(19) United States
(12) Patent Application Publication
(10) Pub. No.: US 2009/0012873 A1
(43) Pub. Date: Jan. 8, 2009

(54) SYSTEMS FOR MANAGING DIGITAL MEDIA DISTRIBUTION

(76) Inventors: Mike Hamling, Sandy, UT (US); Jeremy Bullock, Pleasant Grove, UT (US); Chad Elzinga, Centerville, UT (US); Jonathan Mecham, Tooele, UT (US); Scott Robison, Layton, UT (US); Jesse Hohn, West Jordan, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 12/142,287

(22) Filed: Jun. 19, 2008

Related U.S. Application Data
(63) Continuation-in-part of application No. 11/773,540, filed on Jul. 5, 2007.

(51) Int. Cl. G06Q 30/00; G06F 15/173; G06Q 10/00

(52) U.S. Cl. 705/26; 709/224; 705/30

(57) ABSTRACT

Systems and methods for organizing and managing the collection and distribution of digital content to users via a network of kiosks are described. The systems contain a conglomerate of software applications that can be combined to manage the digital content itself, as well as manage the kiosks that used to distribute the digital content. The software applications are also able to manage the payments received by the users and the payments made to the providers of the digital content. The software applications can be web-based so that they can be accessed and operated via a single portal. Other embodiments are also described.

### CROSS-REFERENCE TO RELATED APPLICATIONS

This application is a continuation-in-part of U.S. application Ser. No. 11/773,540, filed Jul. 5, 2007, the entire disclosure of which is hereby incorporated by reference.

### FIELD

This application relates generally to systems and methods for delivering digital content to a user. In particular, this application relates to systems and methods for organizing and managing the collection and distribution of digital content to users via a network of kiosks.

### BACKGROUND

Many types of information and content are now stored digitally, including books, music, movies, software programs, video games, databases, advertisements, as well as other content. Because such content is stored digitally, it can be transferred easily using many types of electronic networks. See, for example, U.S. Pat. Nos. 5,875,110, 4,412,292, 5,848,398, 6,397,189, 6,381,575, 4,674,055, 5,445,295, 5,734,719, 6,286,029, 6,799,165, 6,655,580, 6,330,490, 6,662,080, 6,535,791, 6,711,464, 5,237,157, 6,654,757, 5,794,217, and 6,748,539. Both private and public electronic networks, including the Internet, are frequently used to transfer the digital content.

Often the digital content is transferred electronically so that it can be sold to a user who is not located where the digital content is originally stored. The digital content can be sold for a variety of purposes, including education, entertainment, research, or other purposes. The digital content may be sold in any number of technological formats known in the art that permit storage and retrieval of the digital data, including floppy discs, compact discs (CDs) of several varieties; video discs of several varieties, including digital video discs (DVDs); magnetic storage devices using a variety of forms and technologies; and solid state devices of several varieties.

Most digital content sales have been to users of computers that are connected to each other via electronic networks of various types, e.g., the Internet. However users are not always located at such a computer when they desire to purchase the digital content, or they have a computer but it is not connected to such a network. Consequently, sales (including rentals) of digital content have begun using devices in remote locations, including stand-alone devices (such as kiosks) in retail or other high-traffic areas. The stand-alone devices may be attended or unattended.

### SUMMARY

This application describes systems and methods for organizing and managing the collection and distribution of digital content to users via a network of kiosks. The systems contain a conglomerate of software applications that can be combined to manage the digital content itself, as well as manage the kiosks that used to distribute the digital content. The software applications are also able to manage the payments received by the users and the payments made to the providers of the digital content. The software applications can be web-based so that they can be accessed and operated via a single portal.

### BRIEF DESCRIPTION OF THE DRAWINGS

The following description can be better understood in light of the Figures, in which:

FIG. 1 depicts an exemplary system for organizing and managing the collection and distribution of digital content;

FIG. 2 illustrates the components in some embodiments of an exemplary distribution device;

FIG. 3 illustrates some embodiments of a portal containing several web-based applications for managing the digital content and the kiosks;

FIG. 4 illustrates some embodiments of a kiosk monitoring site;

FIG. 5 illustrates some embodiments of a kiosk management site;

FIG. 6 illustrates some embodiments of a finance management site;

FIG. 7 illustrates some embodiments of a digital content management site;

FIG. 8 illustrates some embodiments of a digital content management process;

FIG. 9 illustrates some embodiments of a kiosk life cycle; and

FIG. 10 illustrates some embodiments of an administration site.

Together with the following description, the Figures may demonstrate and explain the principles of the systems and methods for organizing and managing the collection and distribution of digital content. In the Figures, the thickness and configuration of components may be exaggerated for clarity. The same reference numerals in different drawings represent the same element, and thus their descriptions will not be repeated.

### DETAILED DESCRIPTION

The following description provides specific details in order to provide a thorough understanding. The skilled artisan, however, would understand that the systems and methods can be practiced without employing these specific details. Indeed, the systems and methods can be practiced by modifying the illustrated systems and methods and can be used in conjunction with apparatus and techniques conventionally used in the industry. While the systems and methods are described for use with a kiosk as a distribution device, the delivery device could include other types of devices, such as vending machines, automated teller machines, coin- or card-operated communications machines (e.g., telephone machines/booths), or remote terminals located in a secure or unsecured public space such as a library, hallway, or outdoor vending area.

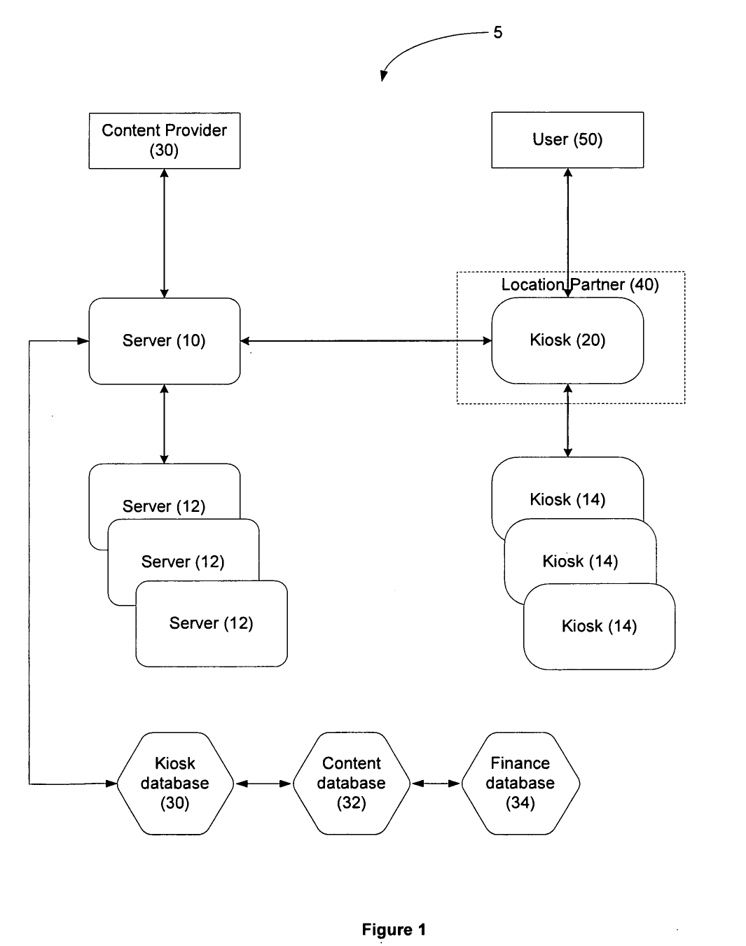

The systems contain a first device in a first location where the digital content can be stored and managed and a distribution device in a second location for delivering the digital content to a user of the content (a kiosk user). In some embodiments, the systems can be illustrated by FIG. 1 where the system 5 contains a first (or storage) device in a first location that stores the digital content and can transfer the digital content to a second (or distribution) device in a second location. The digital content can then be distributed from the second device to the user of the distribution device.

Prior to discussing the details of system 5, it should be understood that the following description is presented largely in terms of operations that may be performed by conventional computer components. These computer components, which may be grouped in a single location or distributed over a wide area, generally include computer processors, memory storage devices, display devices, input devices, etc. that are known in the art. In circumstances where the computer components are distributed, the computer components are accessible to each other via communication links, such as those illustrated in the Figures. The system 5 could equally operate within a computer system having a fewer or greater number of components than those illustrated in the Figures. Thus, the depiction of system 5 should be taken as illustrative and not limiting. For example, the system 5 could implement various services components and peer-to-peer network configurations to implement at least a portion of the processes.

The first location can be located anywhere desired by the operator of the system, i.e., in a central location (with central not referring to the geographic location). The first device can act as a repository for any desired digital content. The first device also permits an operator or administrator (or other system user) of the system 5 to manage all of its operations at a centralized location, permitting roll-out of digital content (and the related materials described herein) across all or select distribution devices and real-time feedback from each distribution device as to its use and functionality.

Any device that can operate in this manner can be used as the first device. One example of the first device comprises a server 10. Any type of server known in the art can be used as server 10. Examples of servers that can be used include a computer running a UNIX-style operating system, a computer running a Microsoft Windows operating system, or a personal computer workstation. The server 10 comprises any storage component on which the digital content can be stored. Examples of storage components include optical storage discs, DVD-RAM discs, and traditional magnetic hard disc drives.

Another example of a storage component includes any known database (or combination of databases). The database stores information regarding the digital content and any user interaction with the system. For example, the database stores data regarding the content inventory at each of the distribution devices. The database can also store sales information, user information, and transactional information. The database may be a Microsoft SQL database, a Microsoft Access database, an Oracle database, a MySQL database or combinations thereof. In some embodiments, the server can contain a kiosk database 30 (or module of a database) for managing and monitoring the distribution devices (kiosk), a digital content database 32 (or module of a database) for managing and monitoring the digital content, and a financial database 34 (or module of a database) for managing and reporting all of the financial transactions in the system. Other databases include those for the status of software modules, the connection history, and the digital media groupings (profiles).

In some aspects, multiple servers 12 may be connected together to make a server cluster. Using a server cluster permits sharing information regarding the content stored on each server 10 and each transaction the server 10 has recorded. By using a server cluster, the system 5 is always operational, regardless of the location of a particular component on the network that connects the components (such as the Internet). The server cluster can contain a primary cluster, which handles all critical tasks, with minor functions being routed to a secondary cluster. With this configuration, if the primary cluster is not operational, most functions can be handled by the secondary cluster. A server cluster also allows for large-scale deployment and interoperability, as well as data that can be stored on the network in multiple points of co-location.

The software components required for operating the server 10 may be included on a single server or on multiple servers, with each server implementing one or more tasks and communicating among themselves using standard networking protocols. Non-limiting examples of the server-focused tasks using the software components that may be implemented on one or more servers 10 include those of e-mail server; Web server; file server; purchase transaction authentication server; transaction push server; monitoring server; content management server; content synchronization server; content security server; and advertising/promotional message server.

As depicted in FIG. 1, the server 10 manages and stores digital content. The types of digital content that can be stored (and then delivered to a user) are virtually unlimited. Examples of the digital content include music, movies, video games, software, mobile phone ring tones, electronic books, advertising, and other types of content. The format in which the digital content is stored is also virtually unlimited. Examples of the types of digital formats include pdf, doc, xls, jpeg, tiff, gif, xbm, pnm, mpeg2, mpeg4, mp3, oma, m4a, wma, wmv, mov, wav, and avi, as well as combinations thereof. The digital content can also be provided in any known language.

The digital content may be provided internally (by the entity that controls or operates the system 5), or externally by one or more third parties that are the copyright owners of the content or that act on behalf of the owners of the content (collectively, content providers 30). Non-limiting examples of content providers 30 include music publishers, video publishers, recording companies, movie studios, television studios, book publishers, artists, performers, end-users, mobile telephone companies, video game manufacturers, and advertisers. Content providers 30 may provide the content to the server using any known mechanism, including via wired or wireless network connections known in the art or via other methods, such as merely providing a CD or DVD to the operator of the system. In some embodiments, the content providers 30 can provide the digital content to a distribution device (s), which can then be transferred to the server 10.

The digital content can include instructions indicating how the content may be used, distributed, sold, transmitted, or otherwise processed (use instructions). The server 10 can convert such use instructions into digital rights management (DRM) information that can be associated with any desired content. The DRM information may include any number or combination of restrictions, including those that are enabled by a DRM technology and that are selected by a content provider 30. Non-limiting examples of DRM restrictions include a restriction that visual or textual content not be printed in hardcopy; a restriction that copy-and-paste functions are disabled for textual content; a restriction that a music file may not be played after a certain date; a restriction that a music file or video file may only be played a fixed number of times; and a restriction that a file may only be copied to another device a fixed number of times. Other examples include variable pricing, variable billing, and variable payment methods.

The DRM information may be provided by a third party (such as content provider 30 or location partner 40) or by the operator of the system 5. Either may assign a unique transactional ID to each piece of digital content. This unique transactional ID correlates to a set of use instructions and DRM specifications to control how the associated content is managed on devices, such as on the server 10, as further described hereinafter. The digital content may therefore contain metadata (i.e. metatags), use instructions, and a transactional ID.

The metadata (i.e., metatags) can correspond to information about any desired content, such as a genre of music or movie, an artist, a content provider, content release date, or otherwise. The metatags may be provided by a content provider 30 or created by the operator of the system. The metatags may indicate the use instructions for all content that is provided, with distinct use instructions for each piece of content, or with use instructions based on parameters that can be used to classify content. In one example of use instructions, a content provider 30 may indicate that music performed by musical artist A may be redistributed freely, without restriction, music performed by musical artist B may be redistributed freely when purchased at a set price, and music performed by musical artist C may be redistributed in a manner that permits the music to be copied to another computer three times, after which the music may not be copied to another computer, but only played (performed) on a computer where it is stored.

The digital content may optionally be encrypted in a manner to increase security of the content during storage on a server 10 or on a distribution device, or during transfer between a content provider 30 and a server 10, or between a server 10 and the distribution device. Any number of encryption methods known to those in the art may be used to implement this feature. Examples of such encryptions include both symmetrical and asymmetrical encryption using a variety of methods, including RSA, DES, Triple DES, AES, Blowfish, ElGamal, RC4, and others.

When the distribution device is placed in a location that is remote from the first device, a location partner 40 can optionally be used in the system 5, as depicted in FIG. 1. The location partner 40 comprises an individual or entity that provides a space where the distribution device may be physically located. Non-limiting examples of such location partners include owners, operators or managers of airports, bars, clubs, schools, gyms, stadiums, arenas, amusement parks, military bases, retail centers, retail stores or shops, convenience stores, eating establishments, correctional facilities, passenger ships, military ships, travel centers or stops, and libraries.

A location partner 40 may provide this space without charge, as a service to individuals that visit the space where the distribution device is placed. Or the location partner 40 may provide this space in exchange for a fee of some type, or in exchange for advertising time on the distribution device, or for any other known benefit. In some embodiments, the location partner 40 may control or limit the content that is available via the distribution device. In other embodiments, the location partner can also control the advertising that is displayed at the distribution device.

As described above, the system also contains a distribution device that can be located in a second location that is optionally remote from the first location. The distribution device receives the content from the first or storage device and then distributes that content to a user of the distribution device (i.e., a kiosk user). Any device operating in this manner can be used as the distribution device. In some embodiments, the distribution device comprises a vending machine or a kiosk, such as the kiosk 20 illustrated in the Figures.

Kiosk 20 provides a point-of-sale (or rental) experience for any user of the kiosk, including both actual and merely potential purchasers of the digital content. Any person can be a user (or kiosk user) by merely interacting with the kiosk 20, whether by purchasing content or merely viewing the kiosk 20 and/or the content on the kiosk, such as by sampling music contained in the kiosk. The kiosk 20 used in the system can be any kiosk known in the art or the kiosk described below. In some embodiments, the kiosk may physically display any known advertising, such as posters, banners, or adhesive advertisements. The kiosk 20 may also be used in conjunction with products as a point-of-purchase display.

The kiosk 20 can contain any combination of number of video displays. In some embodiments, the kiosk 20 contains two video displays, a first video display that displays advertising messages and a second video display that displays menus, samples of content, and related information appropriate to affect a purchase by an end-user of the content made available through the kiosk 20. In other embodiments, though, the kiosk can contain only one video display, as well as three or more video displays. The video display can comprise any known displays, including LED displays, TFT displays, LCD displays, CRT displays, touchscreens, and combinations thereof.

The kiosk 20 can also contain multiple input and output devices appropriate to interact with a kiosk user, display or perform the content stored on the kiosk 20, and complete a sales transaction related to the content. These input and output devices may include, for example, one or more of any of the following: a keyboard; a mouse; a trackball; a joystick; a touchscreen; a label maker; an automatic coupon feeder; a barcode scanner; an image scanner; biometric scanning devices such as a fingerprint, voiceprint, hand geometry, or retinal/iris scanner; a Compact Disc reader; a Compact Disc writer; a video disk reader; a video disk writer; and media device connectivity, including a USB port, an IEEE-1394 FireWire port, a SecureDigital (SD) port, a CompactFlash port, a PCMCIA port, a MemoryStick port, a laser printer, a receipt printer, a video camera, a camera, an audio recorder, a credit/debit/gift card reader, a cash acceptor, a coin acceptor, a check acceptor, a jewel case ejector, a phone docking station, speakers, voice recognition device, signature verifier, facial recognition device, Braille input device, bubble sheet/multiple choice form scanner (such as a Scantron machine), Bluetooth communications, Wi-Fi communications, Wi-Max communications, and other input or output device known in the art. Furthermore, additional input, output, and storage technologies known in the art may be integrated with the kiosk 20, including any and all mobile or portable devices.

The kiosk 20 can also include a controlling device that operates the video displays, interacts with input and output devices, and communicates with other kiosks 20 or servers 10, in real-time or as needed. In some embodiments, the controlling device includes two or more computers, either sharing or dedicated to the needed tasks requisite to controlling the operation. In some configurations, one computer handles the display, selection, and processing of content purchase transactions and a second computer handles the remainder of the tasks required of the kiosk.

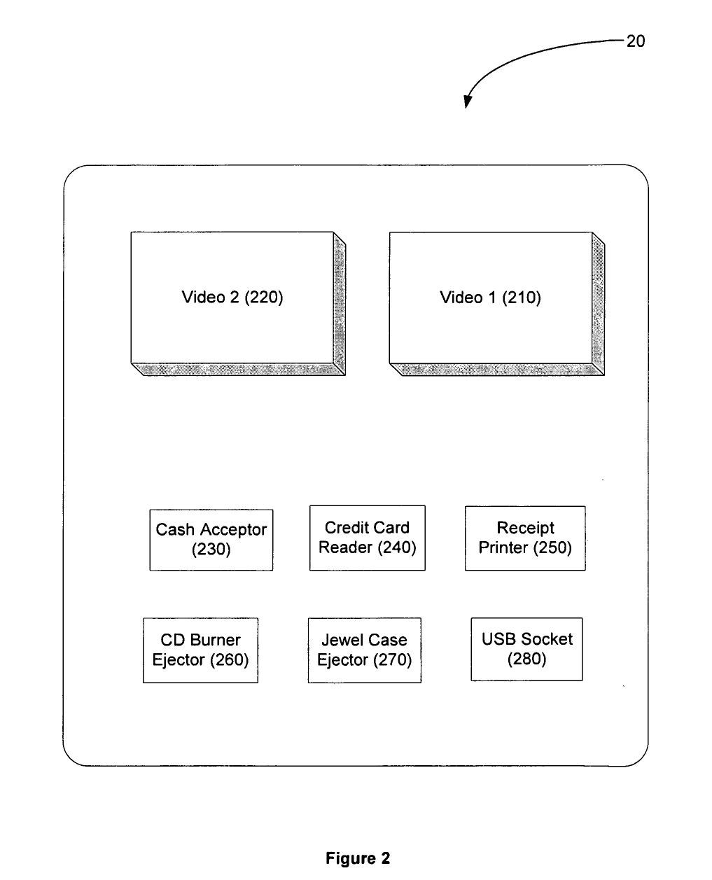

FIG. 2 illustrates one example of kiosk 20. In FIG. 2, kiosk 20 contains a video display 210 on which advertising or promotional messages are displayed; a video display 220 comprising a touch screen device through which a user may view and select content; a cash acceptor 230 through which a user may make payment for content; a credit card reader 240 through which a user may make payment for content; a receipt printer 250 that dispenses a paper receipt of a transaction when content is purchased; a CD burner ejector 260 that dispenses an audio CD containing content selected by an user during a purchase transaction; a jewel case ejector 270 that dispenses an empty jewel case for holding an audio CD; and a USB socket 280 to which an user may connect a device for delivery of content, as described herein. As noted previously, a kiosk 20 may contain different—or additional—components than those shown in FIG. 2, including an end unit that comprises a mobile or portable device.

In some embodiments, the video displays of the kiosk 20 incorporate known touch screen technology. Thus, it can provide a user interface that presents a visual display of pertinent information during the interaction and distribution processes, as well as operate as a user interface for entry of user commands. In some embodiments, the kiosk 20 also includes any known audio technology, such as speakers or headphones.

The kiosk 20 can include a user-friendly interface, including a graphical user interface with a touch screen capability. If desired, multiple interfaces can be incorporated in the kiosk situated at high traffic locations, such as by being positioned on each side of the kiosk. The user interface comprises a hierarchy of pages that a kiosk user navigates through to accomplish different tasks. For example, a kiosk user may search for a specific song, title or artist; once the kiosk user's selection is found, the selection may be sampled, and eventually purchased. The same process applies to all digital content types where a kiosk user can interact with the kiosk 20 to accomplish different tasks associated with the digital content.

When a kiosk user purchases content through a kiosk 20, that content is made available to the kiosk user using any receiving device known in the art. The receiving device can be provided by the kiosk 20 or can be provided by the kiosk user. Non-limiting examples of some content receiving devices can include playback devices or storage devices. Examples of the playback devices include portable computers, MP3 players, iPods®, video players, or mobile/cellular phones. Examples of the storage devices include portable computers, mobile/cellular phones, pagers, text messaging devices, calendar or text information devices, recordable media such as memory chips and cards, CDs and DVDs (or similar video or data discs), writeable data CD such as WORM or CD-RAM, flash drives, USB sticks, or flash memory storage devices. The media content may be stored on these receiving devices magnetically, optically, or electronically as well as any other storage mode known in the art. In some aspects, the digital content can be placed on a receiving device, along with migrated plug-ins or software that can be used to play the digital content received.

The various components of the system can be electronically connected to each other using any means known in the art. In some embodiments, the system 5 contains a computer network. Computer networks are well known in the field of communications. Computer networks may include communication links that extend over a local area or a wide area, or even be global. Examples of these connections include Ethernet, frame relay, DSL, satellite uplink, cable modem, analog modem, fiber channel, infrared and microwave transmissions, wireless communications of various types, and other wired or wireless networking technologies known in the art. Such connections may also be constructed through a publicly accessible network, such as the internet, so long as appropriate security measures, as are known in the art, are used to prevent unauthorized access to the content that passes across the connection. A private network connection may also be used in order to reduce the reliance on such security measures and to further ensure the integrity of content that is transferred via this connection.

The various components of the system are able to communicate with each other whenever needed. In some embodiments, the server 10 and any given kiosk 20 may communicate at regular or scheduled intervals, in real-time, or in an ad hoc manner according to needs that arise as determined by the server 10 or the kiosk 20. Since actual real-time communication may be limited by the transmission speeds available, the communication may be on a substantial or near real-time basis.

In some embodiments, the various components of the system need not be electronically connected. For example, the kiosk 20 need not be connected to the server 10 on a continuous basis. Rather, the kiosk 20 can operate in a stand-alone mode, with digital content being transferred to the kiosk 20 via non-networked means, and purchase transactions and data being collected via non-networked, intermittent means. A stand-alone kiosk 20 can be used, for example, when security procedures and/or network connectivity are not available, such as when a kiosk 20 is located on a military base in a different country than the server 10 from which it would otherwise receive content.

The systems described above can be used to transfer the digital content from the first device to the distribution device, where it then can be optionally distributed to a kiosk user via the receiving device. While the digital content can be transferred by the system in any manner, in some aspects, it can be transferred in a semi-dynamic manner, dynamic, or even static manner. The digital content can also be transferred to any distribution device (or group of devices) at once or one device at a time. The manner in which the digital content is transferred between distribution devices can be controlled by the server that disseminates this information to each distribution device. All aspects of digital content transfers can be controlled, including controlling the times of day for transfers, the upload and download bandwidth of the distribution device, and the content availability.

When a kiosk user views the kiosk, purchases content, or otherwise interacts with the kiosk, the kiosk may collect any desired type of data (collected data). Some examples of collected data may include data about the individual kiosk user (user data), data about the user's interaction with the kiosk (kiosk data), and data concerning the financial transactions at the kiosk location. The kiosk (or other distribution device) may collect the data in any manner known in the art.

For example, during the user's interaction with the kiosk, the kiosk may gather user data. User data may include any information that relates to the kiosk user and/or the user's activities at the kiosk. One example of user data may include conversion data, such as pages viewed, images viewed, color schemes viewed, time of viewing, time of viewing in relation to purchase, content 16 or item(s) purchased/downloaded, requests made, demos/games played, registrations, signups, advertisements viewed, and so forth. Another example of user data may include user browsing activities, such as content viewed, content selected, time spent viewing different content, and total interaction time. Yet another example of user data may be demographic information, such as the user's age, sex, ethnicity, race, marital status, household size, schooling/education, income, profession, languages spoken, citizenship, and the like. Still another example of user information may include survey data, such as consumer satisfaction surveys, event expectation surveys, post-event evaluation surveys, polling/voting data, and so forth. Another example of user data may include user preference data, such as user selected color schemes, content preferences, advertisement preferences, e-mail preferences, and the like. Another example of user data includes user-indicated items of interest, such as forms and genres of entertainment and hobbies. In yet another example, user data may include user account information, such as username, password, address, phone number, e-mail address, unique login identifiers, cookies, user specific survey/conversion data, etc. In still another example, user data may include biometric data, such as fingerprints, voiceprints, hand geometries, retinal/iris scans, signature verifications, facial recognitions, video feed of end-user, pictures taken of end-user, audio recordings, and the like. Moreover, additional information may be collected and/or extrapolated from the any information/data that has been input by the user.

In some embodiments, the data obtained from the kiosk user can include the kiosk user's email account. That account can be used to further customize the kiosk experience for the user. As well, that email account can be used to allow the user to receive additional electronic advertising, including notices of upcoming content, events, products, and similar topics. The user's email account may also be used when sharing the information among a community to which the user belongs. In some instances, the kiosk user can have a membership whether or not the user has an email account. For those users having a membership, the interaction can be customized. The member can enter his/her membership when prompted and can then be presented with customized menus based on past interaction/sales patterns.

The collected data also includes kiosk data. The kiosk data can include any of the user's interaction with the kiosk including, as non-limiting examples, the following: the areas of the content navigation system visited by the user; the advertising content displayed immediately prior to and during the end-user's interaction with the kiosk; the advertising content displayed immediately prior to and during the user's purchase from the kiosk; the nature of the delivery device selected by the user; method of payment; and others.

The collected data also includes financial data. The financial data may include sales transaction data, which may indicate purchases contemplated or completed by the user, content sold, content price, royalty information, inventory ID numbers, transactional IDs, etc. Examples of other types of financial data include payment information, sales information, credit/debit/gift card information, promotional/discount codes, accounting information, and so forth.

The kiosk can operate in either a continuous or a batch mode. In the continuous mode of operation, the collected data for each transaction is transmitted quickly from the kiosk to the server. Then, the collected data is deleted from the memory of the kiosk without storing the data at that particular kiosk. In the batch mode, the collected data for each transaction is retained at the kiosk until such time as the kiosk transmits all of collected data at once.

All of the collected data from the distribution device(s), Web portal, and/or Web page can be used for numerous purposes. In some aspects, the collected data can be used to enhance and/or customize the operation of the system. In other aspects, the collected data can be part of the general and specific market research data that can be used by the operator of the system (or other system user) as known in the art. In yet other aspects, the collected data can be used to customize the content and/or the advertising provided to an external party. For example, the collected data can be used to customize the content delivered to the kiosk or be used to predict the types/genre of media that will be popular to a given kiosk user. Alternatively, the collected data can be used to customize the digital content by the time of day, the geographic location, etc.

The collected data can be used to customize the advertising or promotions directed to the kiosk user. The advertising or promotions may include messages used to market, promote, or sell products or services; or to enhance brand recognition, as well as training materials, entertainment content, community or location information, and other similar materials. The advertising or promotions may also include video clips, audio clips, ring tones, printed coupons, promotional codes, brochures, literature, images, giveaways, discounts associated with digital content, or other promotional or brand-related content. In some embodiments, the advertising or promotions may be presented through video and/or audio presentations, animated PowerPoint presentations, flash programs, banners, pop-ups, screen-savers, wallpapers, posters, digital sampling, cost-per-pixel, cost-per-click, advertisement images, printed advertisements, trademarks and other similar advertisements. One example of the advertising includes the promotion of artists or performers, whose products or content are available for sale on the kiosk. In still another example of the use of the collected data, it may be used in any method of viral marketing.

The kiosk user does not need to physically present at a kiosk to interact with it. The kiosk user can interact with the kiosk via a Web page or Web portal that is in communication with the system 5. In some embodiments, this communication can comprise a wired connection, such as a user accessing the Web page or Web portal via a desktop computer. In other embodiments, though, the communication can comprise a wireless connection, such as a user accessing the Web page or Web portal via a portable electronic device, like a laptop computer, a cellular telephone, or other portable electronic device.

In some embodiments, the systems can contain a single portal (an enterprise portal) for managing the users of the kiosks (the user management process), managing the digital content (the digital content management process), managing and monitoring the kiosks (the kiosk management process), and managing the finances (the financial management process). The enterprise portal contains a conglomerate of web-based applications that, when using the information stored in the respective databases, allows the operator, administrator, or other system user to manage the different processes and the various data. The web-based applications can be provided in a single location so that anyone with proper rights can access the enterprise portal from any location that is in communication with the system 5. Thus, it provides a single point for software updates, eliminating the need to distribute software (i.e., to every kiosk) or to worry about backward compatibility of old software.

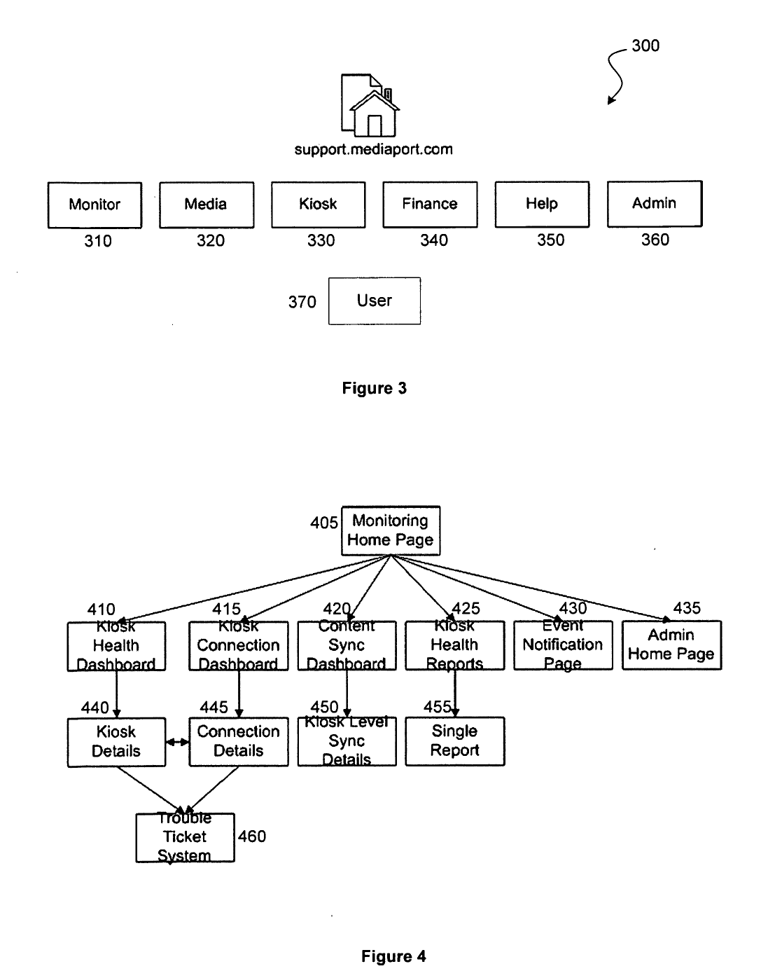

An example of the web-based applications that are accessible via the enterprise portal 300 is illustrated in FIG. 3. FIG. 3 shows several web-based applications on the portal 300 that the system user may have access to and could utilize to perform the various processes. In some embodiments, each one of the web-based applications (or tools) 310 through 370 are shown as tabs that can be accessed by clicking on them, allowing the system user to access that functionality. Additional tools could be added for the functionalities of marketing, customer support, and/or any known function pertaining to the kiosk business. For example, in some configurations, each content provider and/or location partner could have an access portal which could be used by the system user as a message board to communicate with that party. In some embodiments, the web-based applications are integrated into a single location using any known platform, including SQL Server Reporting Services or Microsoft SharePoint.

As depicted in FIG. 3, the enterprise portal 300 can contain a user tool 370. The user tool 370 can be used to manage the kiosk users. This user management process can be used to create kiosk user accounts, delete kiosk user accounts, modify kiosk user accounts, assign rights for certain kiosk users, create and update account information for kiosk users, and/or create a category (i.e., a community) of kiosk users. Kiosk users can also be grouped under companies that will limit access to the kiosks. The companies can be grouped hierarchically to limit the visibility. For example, a top level company may see all the kiosks, a sub-company under the top level company may only see a given sub set of kiosks, and a second cub-company under that sub-company may only see a sub set of the sub set. Also, the visibility may be shared such that two companies at the same level may see some of the same kiosks, but not all of the others kiosks.

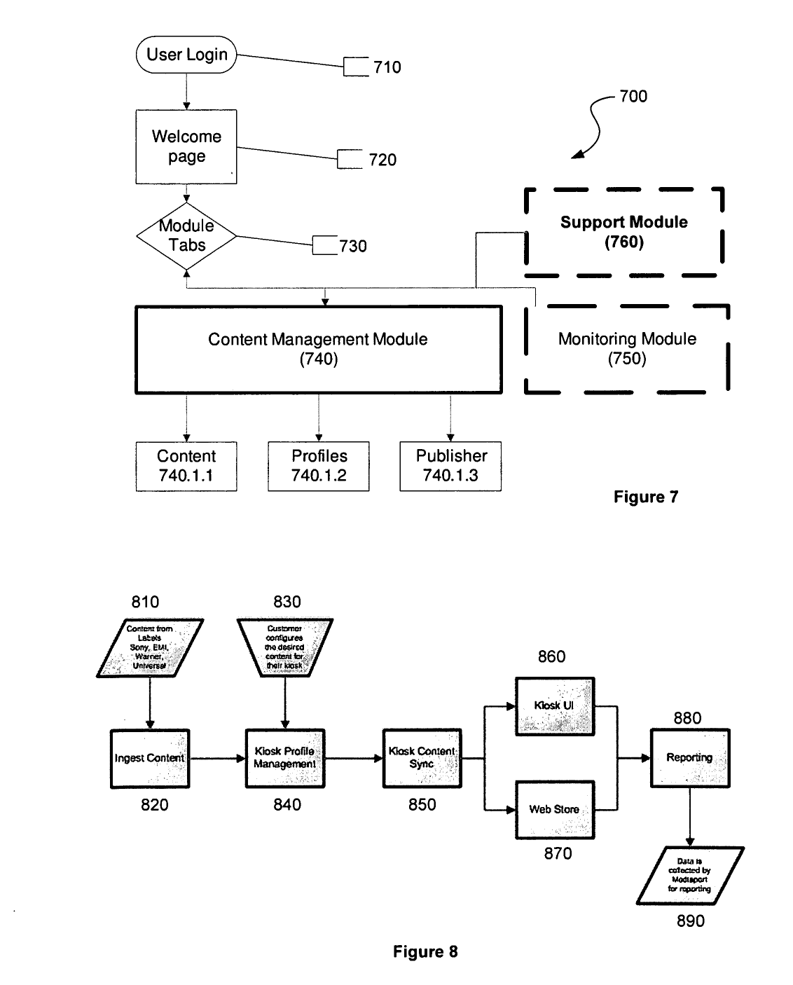

The enterprise portal 300 also contains a media (or content management) tool 320 for performing a content management process. The content management tool 320 allows a system user to access the media management site 700 (illustrated in FIG. 7) which can be used to perform any process for managing the digital content in the system. As shown in FIG. 7, the content management site 700 contains a user login option 710 where the system user can gain access to any content management rights. The welcome page 720 welcomes the system user, has a summary of all the accessible modules and options in the content management site 700, and lists warnings—if any—that might need to be addressed. The content management site 700 also contains module tabs 730 that can be used to navigate through this site.

The content management site 700 also contains a content management module 740. This module contains a welcome screen with information on the last content items that have been updated. This module also contains a warning if any profiles of content groups have exceeded a certain size limitation, or limitation about availability. The content management module 740 can be used by either a system user or a location partner. The location partner will be able to access this module and create and manage the content that will be loaded on kiosks, but only at their locations. The system user can access this module and create and manage the content on any kiosk located in the system. This module 740 is primary responsible for managing the content groups 740.1.1, the content profiles 740.1.2, the content publisher 740.1.3. The content management module 740 can also be used to manage content searches and manage searches. The searches can be performed on any data associated with the content, including title, artist, publisher, date, and/or territory. The searches can be saved to be rerun at a later time. The searches may also be deleted and managed in any known manner like sorted, categorized, and/or associated with entities like content profiles 740.1.2 and content groups 740.1.1.

The content groups 740.1.1 are responsible for managing the content in groups. A group of content has specific attributes that can be maintained for any desired reason. These groups will be controlled by the rights granted for each system user. This configuration will allow the creator of the content to let individuals view or edit a specific content group, including the group attributes, the group functionality, and the group association. The groups can be inclusive or exclusive, thereby defining what content should be added or removed from a content profile 740.1.2.

The content profile 740.1.2 comprises a container of content groups that will be loaded onto a kiosk. Each content profile may have four main areas, including New Releases, Top Sellers, Featured, and Catalog. A system user will be able to add one or more groups to an area within a profile. The content profile includes both the attributes of the profile (i.e., name, size, status, etc.) as well as the functions of the profile (i.e., the various categorizations and exclusions given to the group). The content publisher 740.1.3 can be used to publish a profile to a publishing engine. This engine will create the necessary files that are needed by the kiosk for synchronization of all the content.

The content management site 700 also contains a monitor module 750 and a support module 760 (as shown in FIG. 7). The monitoring module 750 will be used to view and be alerted to problems with kiosks or other servers in the field. The monitoring module can report the overall health of each program and software modules within the software programs running in the kiosks. The monitoring module also test and report network connectivity statistics. The support module 760 can also be used to trouble shoot and track problems in the kiosks.

The content management site 700 can be used in any process of managing the digital content in the system. One exemplary process is illustrated in FIG. 8 and includes ingesting the digital content, creating profiles for the content, and then synchronizing the digital content. Ingest is the process in which the digital content is received from different content providers, as shown in block 810 of FIG. 8, and then integrated into the system, as shown in block 820. This process takes the various pieces of digital content (audio files, video files, etc.), along with the optional metadata provided for each piece of digital content by the content providers 30. For example, the digital content could be provided by the music labels including Sony, EMI, Warner, and/or Universal. The ingest process then converts that information into a standardized format. This conversion process includes storage of digital content in an obfuscated directory structure with encryption. This conversion process also includes translating the metadata to information that substantially matches the metadata organization as it is contained in the system.

Once the digital content has been ingested, the digital content management process continues by management of the content through content profiles 740.1.2. A profile comprises a list of digital content items that are managed as a package and that can be assigned to any location in the system, including any specific kiosk. The profiles can therefore contain a grouping of content with automated rules for managing newly ingested content and filtering, restrictions, and checks. The profiles can be created either by the location provider 40 (as shown in block 830) for a kiosk at his/her location and/or by the operator of the system (as shown in block 840).

The syncing process (shown in block 850) keeps the ever changing profiles throughout the system synchronized with the kiosks in the system. This process requires that a profile be assigned to a kiosk in the field. Once this assignment is in place, then the profile sync process maintains each kiosk's content and keeps it in sync with what the profile, managed at the server, has on record for it. The profile sync process can comprise a peer to peer based system where missing content can be delivered from any location participating in the peer network. This configuration provides a highly scalable solution for transferring content throughout the system. Blocks 860 and 870 illustrate the interface for which the content is made available to the kiosk user. In block 860, this interface is that shown at the kiosk and in block 870, this interface is that shown at the Web store. All data on orders transacted and other user statistics described above can be collected and reported on, as shown in block 880 and 890.

The enterprise portal 300 also contains a kiosk monitoring tool 310 which can be used to monitor the kiosks (or other distribution devices). When accessing this tool, the system user is then directed to the monitoring site 405 (or home page) illustrated in FIG. 4. The monitoring site 405 provides an overview of the health of all kiosks. It provides links to various functions so that the system user can see more details about those monitoring issues they are interested in. The monitoring site 405 also provides a message board of the most recent actions that have happened in the kiosk network. This monitoring includes all hardware and software that makes up the kiosk, and can optionally include information about the kiosk user and the location of the kiosk. The monitoring site 405 can report on all software running on the kiosk every minute. This information is coalesced to the server and displayed for constant feedback about the status of each kiosk.

The monitoring site 405 contains a kiosk health dashboard 410 that provides information about the health status of all kiosks in the system. This dashboard reports warnings and errors and any other kiosk details 440 about the software running on the kiosks. The monitoring site 405 also contains a connection dashboard 415 that reports the status and connection details 445 of the network connectivity of the kiosks. The monitoring site also contains a content synch dashboard 420 that reports the status of the kiosk level content synchronization 450 in all of the kiosks in the system. The monitoring site 405 also contains kiosk heath reports 425 that generate periodic (i.e., daily) health reports 455 and give a summary of all kiosks' health. It can display any kiosk that is not operational and the actions that are being taken to fix it. The monitoring site 405 also contains an event notification function 430 that notifies system users when problems occur. The monitoring site also contains an administration home function 435 that is used to define software versions to be applied to kiosks through the kiosk details page. As depicted in FIG. 4, the monitoring site 405 can be used to generate and monitor a trouble ticket 460. If a problem is found with the kiosk software or with the kiosk connection, the operator can start a trouble ticket to resolve the issue using either the kiosk details function 440 and/or the connection details function 445.

The enterprise portal 300 also contains a kiosk management tool 330 which can be used to manage the kiosks (or other distribution devices). When accessing this tool, the system user is then directed to the management site 510 (or home page) illustrated in FIG. 5. The management site 510 is where kiosks can be created, configured, and managed throughout their lifecycle. The management site contains functions for tracking the kiosk creation 520, providing information about the kiosks 530, configuring the kiosk 540, and grouping the kiosks 550. The kiosk information 530 function and the kiosk configuration 540 function can be used to register the kiosk 560, configure the kiosk 570, and/or configure a group(s) of kiosks 580.

From the moment a kiosk is created, all information about the kiosk (and the kiosk network) can be tracked and recorded using this management site 510. This information is coalesced to the server in the system and displayed for constant feedback about each kiosk. The management site 510 can manage virtually every component of the kiosk, including the inventory and operation of the hardware components in the kiosk, the inventory and operation of the software running on the kiosk, pricing, advertising, promotions, and/or content. Some of the information that is stored about a kiosk can include its street address (or other identifier of its physical location), internet protocol (IP) address, computer equipment (including make and model with serial numbers), and contacts, as well as the conditions of each of these components.

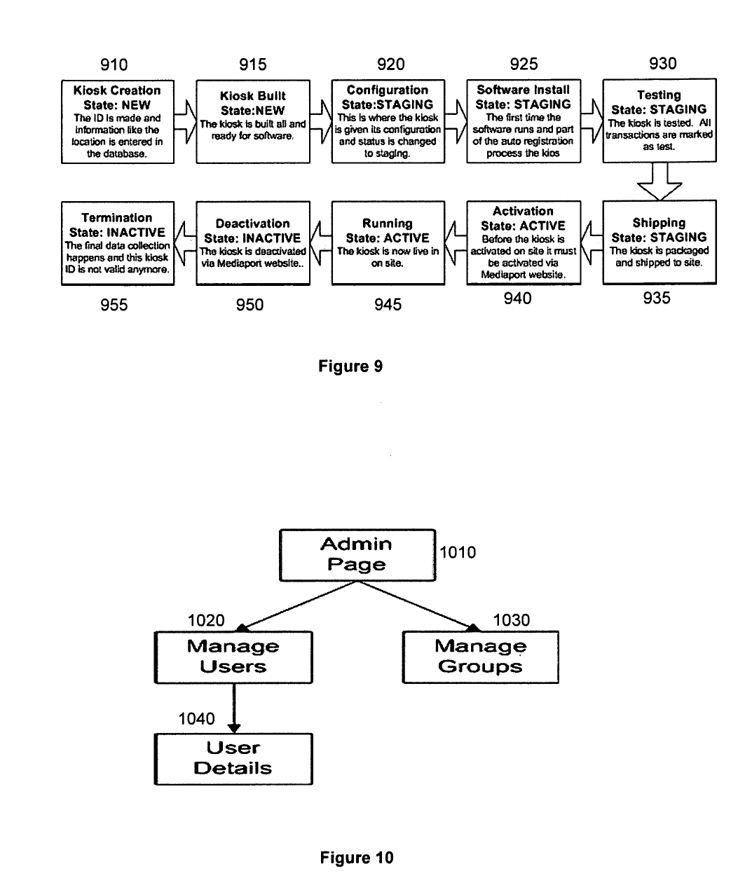

The kiosk management process that can be performed using the kiosk management site 510 can be performed anytime throughout the life cycle of any given kiosk. The life cycle of a kiosk starts with its creation and continues on until its deactivation and/or termination. In some embodiments, an exemplary life cycle of a kiosk is illustrated in FIG. 9. The life cycle begins, as shown in block 910, when a given kiosk is given an identifier (ID). In these embodiments, every kiosk in the system is given an identifier which uniquely identifies each kiosk. No two kiosks can be given the same Kiosk ID. Along with the Kiosk ID, each kiosk can optionally be given a name. The kiosk ID and the names are used to manage the kiosk through out its lifecycle.

The life cycle continues when the kiosk can be manufactured using any known process in the art, as shown in block 915. The kiosk is manufactured to contain any combination of the hardware components described above. Next, as shown in block 920, the kiosk is then configured by installing all of the desired software. Then, the software is operated on the kiosk to auto register the kiosk, shown in block 925. The auto registration process reports and checks if the internet protocol (IP) address is valid for the kiosk before allowing the kiosk application to become functional. Next, as depicted in block 930, the completed kiosk is tested for quality control and to determine software and hardware compatibility. Finally, as illustrated by block 435, the completed kiosk is shipped to the desired physical location and installed.

The life cycle of the kiosk continues when the kiosk is activated. In the activation process, as illustrated in block 940, the kiosk is connected to the communications network of the system and activated first by a system user via the kiosk management site 510. Then, the kiosk is activated at the location. The result is, as shown in block 945, that the kiosk is active at the desired location and ready to interact with a user.

The kiosk life cycle concludes when it is decided to deactivate the kiosk. The kiosk can be deactivated for any number of reasons, including inability to repair any of the needed components, if a location partner hasn't paid on its account, and the location of the kiosk is determined to not be profitable. As shown in block 950 in FIG. 9, the deactivation is performed by the system user via the kiosk management site 510. The kiosk is then terminated, as shown in block 955, when the final data collection from the kiosk is obtained and the kiosk ID is then removed from the system so that it is no longer valid.

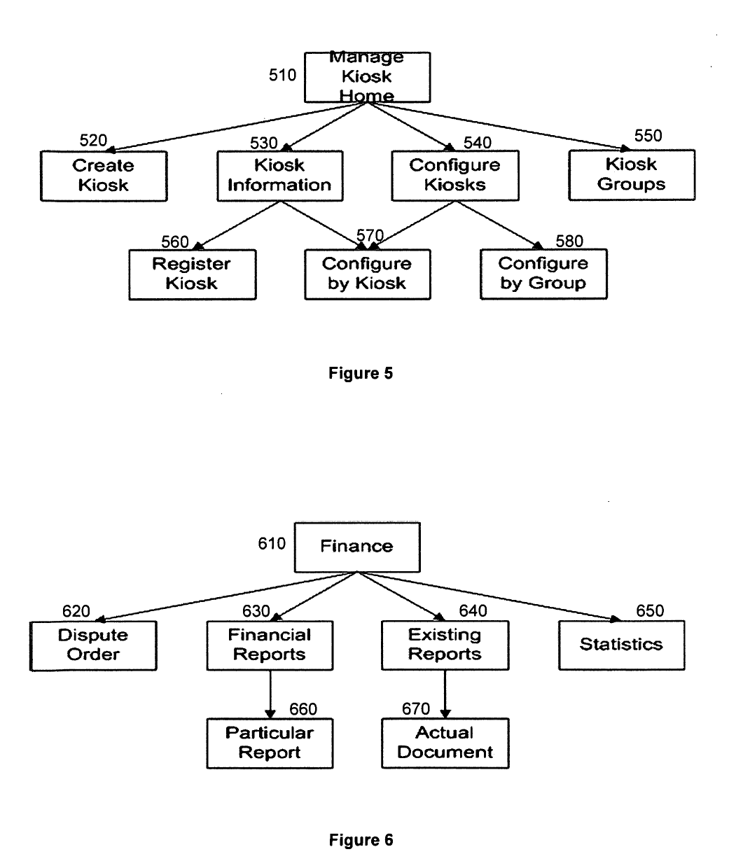

As depicted in FIG. 3, the enterprise portal 300 also contains a finance management tool 340 which can be used to manage the finances in the system. When accessing this tool, the system user is directed to the finance management site 610 (or home page) illustrated in FIG. 6. The finance management site allows 610 the system user to handle any financial process, including a transaction dispute by using a dispute order 620, set pricing of content, generate a new financial report 630, view an existing financial report 640, or generate any statistical report 650. The generation of a new financial report can include a particular report 660, such as a detailed transaction report for any given user transaction with a kiosk and a revenue summary report. Viewing an existing report can include any actual document 670 that has already been reported, including periodic (daily/weekly/monthly/quarterly) reports or label reports which are automatically created on a periodic schedule. The statistical reports that can be generated include any types of sales report, including sales by country (or region), sales by an artist, sales at a given location, and cash sales or credit sales.

The financial management process that can be performed using the finance management site 610 encompasses all of the needed procedures for collecting all user transactions that are occurring on each kiosk, all of the payments made to the content providers, all transactions with any location providers, generating sales reports, and resolving disputes. The financial management process can provide a single point of access to all of this financial information. The financial management process is thereby able to facilitate the flow of financial information within the system and automatically generate reports and notifications about any desired financial information.

The financial management process operates in the following manner. New transactional information (if available) is automatically transferred from each kiosk on a periodic basis, i.e., about every minute. The transaction information is transferred to the financial database on the server. This transfer keeps the system substantially up to date with the current sales at all kiosk sites. This transfer is performed with a software application that runs silently on each kiosk. As well, new transactional information for the content providers and/or the location partners can be updated on a periodic basis and if not already present at the server, transferred from the location of the content provider and/or the location partner to the server.

The financial management process can provide a plethora of reports that queries the collected data in for any desired information. These reports can be generated on a one-time basis, for example, at the request of the operator, a content provider, or a location partner. As well, the reports can be generated automatically. For example, the automated reports may be generated and sent to a location partner on a daily, weekly, or monthly retail report of the transactions at their kiosks. In another example, a content provider could receive a label report of all the digital content sold under its label.

There exist numerous types of financial reports that can be generated. For example, an operator can query and receive a detailed retail transactions report for any time period on any number of kiosks. In another example, the operator of the system may request a transactions summary report on a particular kiosk user and his activities as a kiosk.

Another function of the financial management process can include controlling the pricing of digital content at the kiosks. Every piece of digital content can be associated with a price code from a price code table. This table can then be changed using the financial management process by those having rights to change the price.

Another function of the financial management process can include resolving and reconciliation of disputes. The financial module provides an interface where those kiosk users are given access to it can enter the orders that they would like to dispute and then the financial module can reconcile their statements with those kiosk users.

The enterprise portal 300 also contains an administrative tool 360 that can direct the system user to the administrator site 1010 illustrated in FIG. 10. The administrator site 1010 can be used to create and remove system users (which are different than the user of the kiosks). Only system users with administration rights have access to the administrator site. The system users that are created under this site can only have equal or lesser access than the system user that created them. When creating system users, they can be assigned different privileges to limit their access and abilities on the site. As well, groups of system users can be also created and managed using the administrator site.

As depicted in FIG. 10, the administrator site 1010 can manage system users 1020 and manage groups of system users 1030. The user details 1040 or the rights that system users can exercise are also controlled using the administrator site 1010. System users can be given the following rights: access to all kiosks under a specific company or location partner; access to a group or sub-group of kiosks; monitoring the read/write access for kiosk status, connectivity, and synchronization status; support rights for trouble tickets, knowledge base; FAQ (frequently asked questions), software applications, and documentation; create, read, and modify digital content profiles, including specific parts of the content profile; kiosk management, including creating kiosk, editing kiosk information, and editing kiosk configurations; and financial rights to any information or reports at the kiosk level or the system level.

The enterprise portal 300 also contains a help tool 350 which directs the system user to a help site. The help site can provide a knowledge base and FAQ page where the system user can browse and find answers to any problem(s) he or she is having. With the needed access, the system user will be able to download software updates and documentation from the help site.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A system for distributing digital content, comprising:
a storage device capable of storing digital content;
a distribution device capable of distributing the digital content to a user of the distribution device;
a communications network connecting the storage device and the distribution device; and
a portal for managing the storage device and the distribution device containing:
computer executable commands for managing the digital content;
computer executable commands for managing the distribution device;
computer executable commands for monitoring the distribution device; and
computer executable commands for managing information about the user.

2. The system of claim 1, further comprising multiple distribution devices.

3. The system of claim 1, wherein the distribution device also stores the digital content.

4. The system of claim 1, wherein the user can purchase the digital content and the portal further comprises computer executable commands for managing the financial information of the purchase.

5. The system of claim 1, wherein the storage device comprises a server and the distribution device comprises a kiosk.

6. The system of claim 1, wherein the computer executable commands for monitoring the distribution device can monitor hardware and software operating on the kiosk, can monitor the connection of the kiosk to the communication network, or status of the content synchronization of the kiosk.

7. The system of claim 1, wherein the computer executable commands for managing the distribution device can create a unique identification for the kiosk, can configure the software operating on the kiosk, can register the kiosk with the server, and can collect information about the operating status of the kiosk.

8. The system of claim 1, wherein the computer executable commands for managing the digital content can ingest the digital content from a content provider, can create content profiles, and can synchronize the digital content on the kiosk with the system.

9. The system of claim 5, wherein the computer executable commands for managing the financial information can resolve a transaction dispute, set pricing of the digital content, generate a new financial report, view an existing financial report, or generate a statistical report.

10. A system for distributing digital content, comprising:
a server that stores digital content;
a kiosk capable of distributing the digital content to a purchaser of the digital content;
a communications network connecting the server and the kiosk; and
a portal for managing the server and the kiosk containing:
computer executable commands for managing the digital content;
computer executable commands for managing the kiosk;
computer executable commands for monitoring the kiosk;
computer executable commands for managing the financial information of the purchase; and
computer executable commands for managing information about the purchaser.

11. The system of claim 10, further comprising multiple distribution devices.

12. The system of claim 10, wherein the distribution device also stores the digital content.

13. The system of claim 10, wherein the computer executable commands for monitoring the distribution device can monitor hardware and software operating on the kiosk, can monitor the connection of the kiosk to the communication network, or status of the content synchronization of the kiosk.

14. The system of claim 10, wherein the computer executable commands for managing the distribution device can create a unique identification for the kiosk, can configure the software operating on the kiosk, can register the kiosk with the server, and can collect information about the operating status of the kiosk.

15. The system of claim 10, wherein the computer executable commands for managing the digital content can ingest the digital content from a content provider, can create content profiles, and can synchronize the digital content on the kiosk with the system.

16. The system of claim 10, wherein the computer executable commands for managing the financial information can resolve a transaction dispute, set pricing of the digital content, generate a new financial report, view an existing financial report, or generate a statistical report.

17. A computer-implemented method for distributing digital content to a user, the method comprising:
providing a system comprising a storage device capable of storing digital content, a distribution device capable of distributing the digital content to a user of the distribution device, a communications network connecting the storage device and the distribution device, and a portal for managing the storage device and the distribution device which computer executable commands for managing the digital content, for managing the distribution device, for monitoring the distribution device, and for managing information about the user;
allowing a user to select digital content;
transferring the selected digital content to the distribution device if the selected digital content is not already located at that device; and
distributing the selected digital content from the distribution device to the user.

18. The method of claim 17, wherein the system comprises multiple distribution devices.

19. The method of claim 17, wherein the storage device comprises a server and the distribution device comprises a kiosk.

20. The method of claim 19, wherein the computer executable commands for monitoring the distribution device can monitor hardware and software operating on the kiosk, can monitor the connection of the kiosk to the communication network, or status of the content synchronization of the kiosk.

21. The method of claim 19, wherein the computer executable commands for managing the distribution device can create a unique identification for the kiosk, can configure the software operating on the kiosk, can register the kiosk with the server, and can collect information about the operating status of the kiosk.

22. The method of claim 19, wherein the computer executable commands for managing the digital content can ingest the digital content from a content provider, can create content profiles, and can synchronize the digital content on the kiosk with the system.

23. The method of claim 19, wherein the computer executable commands for managing the financial information can resolve a transaction dispute, set pricing of the digital content, generate a new financial report, view an existing financial report, or generate a statistical report.
